(19) United States
(12) Patent Application Publication
(10) Pub. No.: US 2020/0110044 A1
(43) Pub. Date: Apr. 9, 2020

(54) IMAGE DISPLAYING APPARATUS, RADIOGRAPHIC IMAGING SYSTEM, AND RECORDING MEDIUM

(71) Applicant: KONICA MINOLTA, INC., Tokyo (JP)

(72) Inventors: Kosuke FUKAZU, Tokyo (JP); Masahiro KUWATA, Tokyo (JP); Koutarou KANAMORI, Tokyo (JP); Nobuyuki MIYAKE, Yokohama-shi (JP)

(21) Appl. No.: 16/583,460

(22) Filed: Sep. 26, 2019

(30) Foreign Application Priority Data
Oct. 3, 2018 (JP) 2018-187971

(51) Int. Cl. G01N 23/04; G06F 3/14

(52) U.S. Cl. CPC G01N 23/04; G01N 2223/42; G01N 2223/408; G06F 3/14

(57) ABSTRACT

Disclosed is an image displaying apparatus, including: a hardware processor that: acquires a series of frames of a dynamic image from a radiographic imaging apparatus that generates the series of frames at a predetermined imaging frame rate based on received radiation; stores the acquired series of frames in a storage; selects frames to be used for display from the series of frames stored in the storage by picking up a frame from every predetermined number of frames; and displays an edited dynamic image composed of the selected frames on a display.

### CROSS REFERENCE TO RELATED APPLICATION

The present application claims priority under 35 U.S.C. § 119 to Japanese Patent Application No. 2018-187971, filed on Oct. 3, 2018, the entire content of which is incorporated herein by reference.

### BACKGROUND

### Technological Field

The present invention relates to an image displaying apparatus, a radiographic imaging system, and a recording medium.

### Description of the Related Art

In a radiographic imaging system including a radiation generating apparatus capable of generating radiation and a radiographic imaging apparatus capable of generating a radiographic image based on the received radiation, the radiographic imaging apparatus repeats accumulation and readout of electric charges at a predetermined frame rate to capture a dynamic image composed of a series of radiographic images as respective frames.

Captured frames are transmitted to a displaying apparatus (for example, a console) having a display and displayed there as a dynamic image. The radiographer or the like checks the dynamic image displayed on the display device to determine whether or not the imaging has been successfully performed without any problem.

In conventional radiographic imaging systems, the frame rate is fixed. In recent years, however, radiographic imaging systems have been introduced that can switch between a plurality of different frame rates for imaging.

For example, JP 2009-017476 A describes an imaging control device that causes a sensor to perform dummy accumulation and dummy readout before the next radiation is emitted after an image is read out in a case where the emission intervals of radiation are extended so that the charge accumulation time of each frame becomes longer than the reference time.

JP 2005-287773 A describes an imaging system that converts a part of a readout operation repeated in an image capturing apparatus to an operation for obtaining an offset output in a case where an imaging mode with a relatively long radiation emission cycle is selected.

However, in radiographic imaging systems capable of changing the frame rate as described in JP 2009-017476 A and JP 2005-287773 A, it is necessary to change the control of accumulation and readout of the radiographic imaging apparatus according to a selected frame time. Therefore, since not only the radiation generating apparatus but also the radiographic imaging apparatus needs to be designed differently from a case where the frame rate is fixed, the configuration of the radiographic imaging apparatus becomes complicated proportionally.

### SUMMARY

An object of the invention is to make it possible to capture a dynamic image composed of a series of frames at a plurality of different frame rates even if a radiographic imaging apparatus used for capturing the dynamic image supports only imaging at a predetermined frame rate.

To achieve at least one of the abovementioned objects, according to a first aspect of the present invention, an image displaying apparatus reflecting one aspect of the present invention comprises a hardware processor that:

acquires a series of frames of a dynamic image from a radiographic imaging apparatus that generates the series of frames at a predetermined imaging frame rate based on received radiation;

stores the acquired series of frames in a storage;

selects frames to be used for display from the series of frames stored in the storage by picking up a frame from every predetermined number of frames; and

displays an edited dynamic image composed of the selected frames on a display.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a block diagram of a radiographic imaging system according to a first embodiment (second embodiment) of the invention;

FIG. 2 is a block diagram illustrating a radiation generating apparatus provided in the radiographic imaging system illustrated in FIG. 1;

FIG. 3 is a waveform illustrating a time-dependent change of radiation generated by the radiation generating apparatus illustrated in FIG. 2;

FIG. 4 is a block diagram illustrating an image displaying apparatus provided in the radiographic imaging system illustrated in FIG. 1;

FIG. 5 is a flowchart of a dynamic image editing process performed by the image displaying apparatus illustrated in FIG. 4;

FIG. 6 is a conceptual diagram of frame selection in the dynamic image editing process illustrated in FIG. 5;

FIG. 7 is a sequence diagram illustrating the operation of the radiographic imaging system illustrated in FIG. 1; and

FIG. 8A to FIG. 8D are schematic diagrams illustrating a pixel selection method in a dynamic image editing process in a second embodiment.

### DETAILED DESCRIPTION OF EMBODIMENTS

Hereinafter, one or more embodiment of the present invention will be described with reference to the drawings. However, the scope of the invention is not limited to the disclosed embodiments.

### First Embodiment

Hereinafter, a first embodiment of the invention will be described in detail with reference to FIG. 1 to FIG. 7.

[Radiographic Imaging System]

First, the schematic configuration of a radiographic imaging system (hereinafter, referred to as a system 100) according to the present embodiment will be described. FIG. 1 is a block diagram of the system 100. Reference numerals in parentheses in FIG. 1 are those in a second embodiment to be described later.

As illustrated in FIG. 1, the system 100 includes a radiation generating apparatus (hereinafter, referred to as a generation apparatus 1), a radiographic imaging apparatus (hereinafter, referred to as an imaging apparatus 2), and an image displaying apparatus 3.

The system 100 may be connectable to other systems, such as a radiology information system (RIS) (not illustrated) and a picture archiving and communication system (PACS) (not illustrated).

The system 100 may include a console that allows the user or the like to set the imaging conditions and the like of the generation apparatus 1 or the imaging apparatus 2.

The generation apparatus 1 includes a generator 11, an irradiation switch 12, and a radiation source 13.

Although FIG. 1 exemplifies a case where the generator 11, the irradiation switch 12, and the radiation source 13 are separated from each other, these may be integrated.

FIG. 1 exemplifies a case where the irradiation switch 12 is connected to the generator 11, but the irradiation switch 12 may be provided in other apparatuses (for example, a console (not illustrated)).

The generation apparatus 1 may be installed in an imaging room, or may be configured to be movable, such as being provided in a visiting car or the like.

Details of the generation apparatus 1 will be described later.

The imaging apparatus 2 is configured to be able to generate a radiographic image of a subject (a person, an animal, or an object) based on radiation received from the generation apparatus 1 through the subject.

Specifically, the imaging apparatus 2 includes: a radiation detector in which pixels including switch elements or radiation detection elements that generate electric charges according to the dose of received radiation are arranged two-dimensionally (in a matrix); a reader that reads out the amount of electric charges discharged from each pixel as a signal value and generates radiographic image data from a plurality of signal values; a communicator that transmits and receives various control signals, various kinds of data, and the like to and from other apparatuses (for example, the image displaying apparatus 3) or transmits the generated radiographic image data to the other devices; and the like.

The imaging apparatus 2 according to the present embodiment configured as described above can switch between still image capture and dynamic image capture, which is composed of a series of frames, based on the settings of the imaging apparatus 2 or an instruction from a console (imaging control device, not illustrated).

The imaging apparatus 2 repeatedly generates a frame at a predetermined imaging frame rate (for example, N frames/second (fps)) when capturing a dynamic image. Specifically, an operation of accumulating electric charges in pixels and an operation of reading out the electric charges discharged from the pixels as an image are repeated N times per unit time.

The imaging apparatus 2 transmits a plurality of generated frames to the image displaying apparatus 3 through a communicator.

The imaging apparatus 2 may transmit the generated frames in a sequential manner (each time a frame is generated), or may transmit a plurality of frames collectively.

The imaging apparatus 2 may be an apparatus with a built-in scintillator and the like that converts emitted radiation into light having another wavelength, such as visible light, with the scintillator and generates electric charges according to the converted light (so-called indirect type), or may be an apparatus that generates electric charges directly from radiation without using a scintillator (so-called direct type).

Alternatively, the imaging apparatus 2 may be a cooperative type apparatus that performs the above-described imaging operation based on signals received from other apparatuses or the like, or may be a non-cooperative type apparatus that starts imaging automatically in response to detection of radiation from the generation apparatus 1.

Alternatively, the imaging apparatus 2 may be a dedicated type apparatus integrated with an imaging table, or may be a portable type (cassette type) apparatus.

The image displaying apparatus 3, which is constituted by a PC, a portable terminal, or a dedicated device, can communicate with at least the imaging apparatus 2 by wire or wirelessly.

The image displaying apparatus 3 can acquire a dynamic image generated by the imaging apparatus 2 and display the dynamic image.

The image displaying apparatus 3 may be configured as a console (imaging control device) by imparting a function of controlling the generation apparatus 1 or the imaging apparatus 2 (for example, a function of designating the frame rate of the generation apparatus 1 or the imaging apparatus 2).

Details of the image displaying apparatus 3 will be described later.

[Radiation Generating Apparatus]

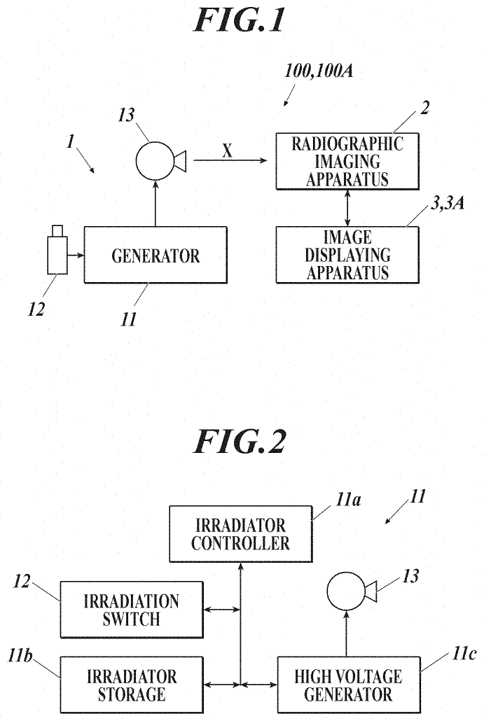

Next, details of the generation apparatus 1 provided in the system 100 will be described. FIG. 2 is a block diagram illustrating the generation apparatus 1.

As illustrated in FIG. 2, the generator 11 of the generation apparatus 1 includes an irradiator controller 11a, an irradiator storage 11b, a high voltage generator 11c, and the like.

The irradiator controller 11a includes a CPU, a RAM, and the like, and integrally controls the operation of the components of the generation apparatus 1.

The irradiator controller 11a transmits a timing signal to the high voltage generator 11c in response to the irradiation switch 12 being operated. The timing signal is transmitted once with respect to each operation of the irradiation switch 12 in a case where still image capturing is selected, and the timing signal is repeatedly transmitted at predetermined periods with respect to each operation of the irradiation switch 12 in a case where dynamic image capturing is selected.

The irradiator storage 11b, which is constituted by a hard disk drive (HDD), a semiconductor memory, or the like, stores various processing programs, parameters or files required to execute the processing programs, and the like.

The high voltage generator 11c applies a voltage according to preset imaging conditions (for example, conditions regarding a subject, such as a part to be imaged and a physique, or conditions regarding irradiation, such as a tube voltage, a tube current, an irradiation time, and a current time product (mAs value)) to the radiation source 13 (tube) in response to reception of the timing signal from the irradiator controller 11a. In a case where dynamic image capturing is selected, a pulsed voltage is repeatedly applied to the radiation source 13 each time a timing signal is received.

When a voltage is applied from the high voltage generator 11c, the radiation source 13 generates radiation (for example, an X-ray) of a dose corresponding to the applied voltage. Specifically, when a pulsed voltage is repeatedly applied from the high voltage generator 11c, pulsed radiation (hereinafter, referred to as a radiation pulse) is repeatedly generated.

The generation apparatus 1 according to the present embodiment configured as described above can switch between the generation of radiation for still image capturing and the generation of radiation for dynamic image capturing.

The generation apparatus 1 repeatedly generates a plurality of radiation pulses at a predetermined irradiation frame rate in the case of capturing a dynamic image.

The generation apparatus 1 can switch the irradiation frame rate. Specifically, it is possible to switch the irradiation frame rate between a first irradiation frame rate (N frames/second (fps)), which is the same as the imaging frame rate when the imaging apparatus 2 generates frames of the dynamic image, and a second irradiation frame rate that is 1/M (M is an integer of 2 or more) of the first irradiation frame rate.

Switching between the still image capturing and the dynamic image capturing or switching of the irradiation frame rate may be performed based on a user operation performed on an operation interface (not illustrated) provided in the generation apparatus 1, or may be performed based on an instruction received from a console (not illustrated) through a communicator (not illustrated).

In the present embodiment, the second irradiation frame rate can be selected from two values of N/2 fps and N/4 fps.

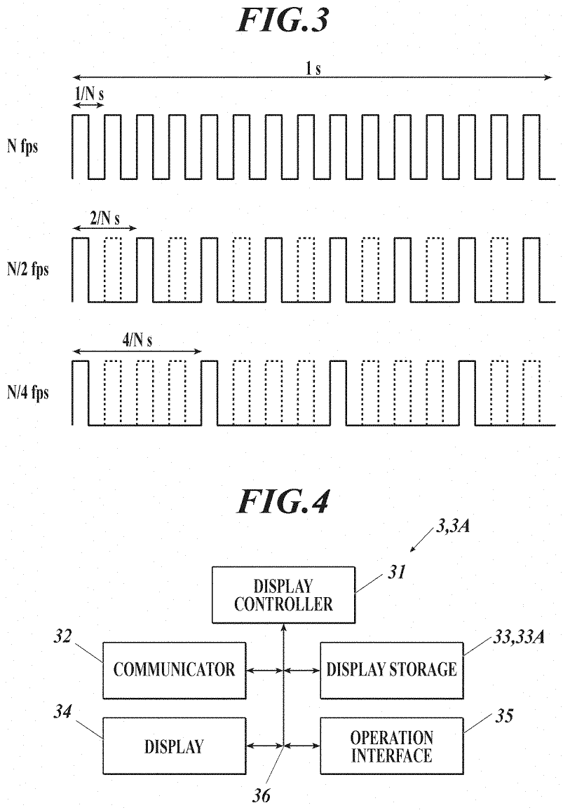

In a case where the first irradiation frame rate (N fps) is selected, as illustrated in the upper part of FIG. 3, a radiation pulse is generated every 1/N second. On the other hand, in a case where the second irradiation frame rate of N/2 fps is selected, a radiation pulse is generated every 2/N seconds. That is, when the time-dependent change of the radiation is illustrated as a waveform, as illustrated by the solid line in the middle of FIG. 3, one radiation pulse rises every two irradiations at the first irradiation frame rate.

On the other hand, in a case where the second irradiation frame rate of N/4 fps is selected, a radiation pulse is generated every 4/N seconds. That is, when the time-dependent change of the radiation is illustrated as a waveform, as illustrated in the lower part of FIG. 3, one radiation pulse rises every four irradiations at the first irradiation frame rate.

[Image Displaying Apparatus]

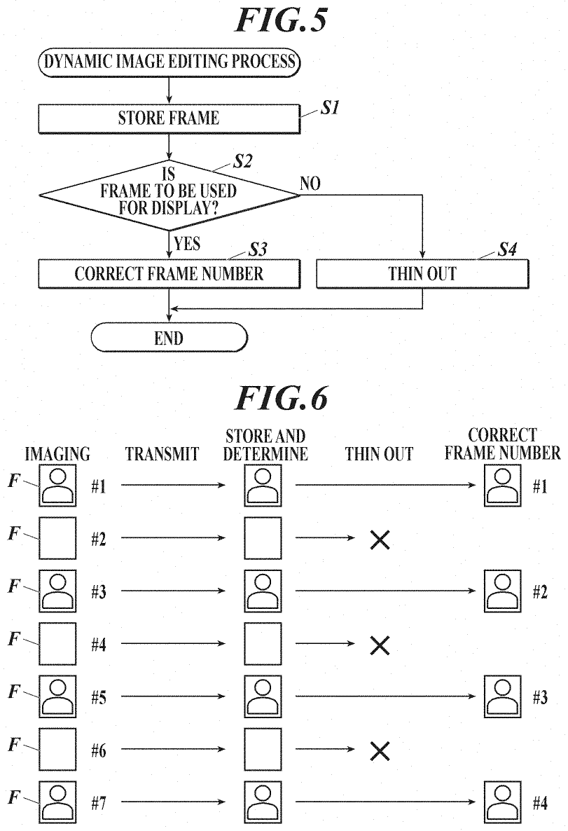

Next, details of the image displaying apparatus 3 provided in the system 100 will be described. FIG. 4 is a block diagram illustrating the image displaying apparatus 3, and FIG. 5 is a flowchart of an image editing process performed by the image displaying apparatus 3. Reference numerals in parentheses in FIG. 4 and FIG. 5 are those in the second embodiment to be described later.

As illustrated in FIG. 4, the image displaying apparatus 3 includes a display controller 31, a communicator 32, a display storage 33, a display 34, an operation interface 35, and a bus 36 for connecting the components to each other.

The display controller 31 (hardware processor) includes a central processing unit (CPU), a random access memory (RAM), and the like. The CPU of the display controller 31 centrally controls the operation of each component of the image displaying apparatus 3 by reading out various programs stored in the display storage 33 according to the operation of the operation interface 35, loading the programs to the RAM, and performing various kinds of processing according to the loaded programs.

The communicator 32, which is constituted by a network interface or the like, transmits and receives data to and from other apparatuses connected by wire or wirelessly through a communication network, such as a LAN, a WAN, or the Internet.

Instead of the communicator 32 or separately from the communicator 32, a connector (for example, a USB port) for connection with a storage medium may be provided.

The display storage 33 includes a non-volatile semiconductor memory, a hard disk, or the like, and stores various processing programs to be performed by the display controller 31 (including dynamic image editing processing programs to be described later), parameters required to perform the process by the programs, and the like.

The display storage 33 can store radiographic image data, which is received from the imaging apparatus 2 or obtained by processing of the display controller 31, along with accessory information.

The display 34, which is constituted by a monitor, such as a liquid crystal display (LCD) or a cathode ray tube (CRT), displays an input on the operation interface 35, a radiographic image, and the like according to an instruction by a display signal input from the display controller 31.

The operation interface 35, which includes a keyboard having cursor keys, numeric input keys, various function keys, and the like and a pointing device, such as a mouse, outputs an instruction signal input by a key operation on the keyboard or a mouse operation to the display controller 31.

The operation interface 35 may include a touch panel on the display screen of the display 34. In this case, an instruction signal input through the touch panel is output to the display controller 31.

The display controller 31 of the image displaying apparatus 3 configured as described above has a function of setting the irradiation frame rate of the generation apparatus 1, for example.

The irradiation frame rate may be set to a value input by an operation on the operation interface 35, or a value acquired from other apparatuses (a console and the like).

The setting of the irradiation frame rate may be performed at any timing before execution of a dynamic image displaying apparatus to be described later.

The display controller 31 has a function of acquiring a plurality of frames for forming a dynamic image captured by the imaging apparatus 2.

In the present embodiment, frame data is directly received from the imaging apparatus 2 through the communicator 32.

Frames may be sequentially acquired, or frames may be stored in the imaging apparatus 2 and collectively acquired later.

In a case where the image displaying apparatus 3 includes a connector for connection with a storage medium, frame data stored in the storage medium may be acquired.

The display controller 31 has a function of performing a dynamic image editing process, for example, as illustrated in FIG. 5 each time a frame is acquired from the imaging apparatus 2, for example.

In the dynamic image capturing, since the imaging apparatus 2 generates a plurality of frames and sequentially transmits the frames to the image displaying apparatus 3, the dynamic image editing process is repeated as many as the number of frames generated by the imaging apparatus 2 (until the number of times of execution reaches the maximum number of imagings).

In the dynamic image editing process, first, an acquired frame is stored in the display storage 33 (step S1).

In the dynamic image editing process according to the present embodiment, this step S1 is always performed. Accordingly, all the acquired frames are stored.

Of the repeatedly performed dynamic image editing processes, the first or last one or more dynamic image editing processes may not involve step S1 so that the first or last one or more frames of the dynamic image are not stored.

The display controller 31 stores a plurality of acquired frames by repeatedly performing step S1.

After storing the frame, it is determined whether or not the stored frame is to be used for display (step S2).

In the present embodiment, it is determined whether or not the stored frame is to be used for display based on the set irradiation frame rate and accessory information attached to the dynamic image.

For example, the accessory information includes a frame number (serial number) assigned to each frame.

In a case where the set irradiation frame rate is the first irradiation frame rate (N fps), since the radiation generation cycle of the generation apparatus 1 and the frame generation cycle of the imaging apparatus 2 are the same, the subject is shown in all frames. In this case, therefore, it is determined that all the frames are to be used for display.

On the other hand, in a case where the set irradiation frame rate is the second irradiation frame rate (N/M fps), the subject is shown in one in every M sheets (the subject is not shown in the other (M−1) sheets in every M sheets). Therefore, it is determined that the stored frames are to be used for display if the frame number assigned to the frame is 1, 1+M, and 1+2M, . . . , and it is determined that the stored frame is not to be used for display if the frame number assigned to the frame is the other numbers.

For example, in a case where the set second irradiation frame rate is N/2 fps, for example, as illustrated in FIG. 6, a frame F in which the subject is shown is generated every other sheet. Therefore, it is determined that the stored frame is to be used for display if the frame number is an odd number (#1, #3, #5, . . . ) (step S2; Yes), and it is determined that the stored frame is not to be used for display if the frame number is an even number (#2, #4, #6, . . . ) (step S2; No).

In a case where the generation apparatus 1 is configured to start emitting radiation from the second frame, in step S2, it is determined that the stored frame is to be used for display if the frame number is an even number, and it is determined that the stored frame is not to be used for display if the frame number is an odd number.

In a case where it is determined that the stored frame is to be used for display in step S2 (step S2; Yes), as illustrated in FIG. 5, the frame number is corrected (step S3), and the dynamic image editing process ends.

In step S3, #1 is assigned to a frame determined first to be used for display. Thereafter, every time step S3 is repeated, a value obtained by adding 1 to the frame number corrected in previous step S3 is reassigned as a new frame number.

On the other hand, in a case where it is determined that the stored frame is not to be used for display (step S2; No), the frame is thinned out (step S4), and the dynamic image editing process ends.

Specifically, a correspondence relationship with the dynamic image is eliminated by deleting the frame number, for example.

The thinned-out frame may be deleted or may remain stored. Deleting the thinned-out frame saves the storage space of the display storage 33, and keeping the thinned-out frames enables the frames to be used later for debugging or image correction.

By repeating steps S2 to S4, the display controller 31 selects frames to be used for display from the stored series of frames at a pace of one in every predetermined number of frames.

After the repetition of the dynamic image editing process ends, only the frames to be used for display are selected from the plurality of frames, and the frame numbers thereof are corrected.

Hereinafter, a dynamic image composed of the selected frames (with corrected frame numbers) is referred to as an edited dynamic image.

In the dynamic image editing process, before step S2, a step of checking whether or not the subject is shown in the first one or more frames may be performed, and the process proceed to step S2 if it is confirmed that the subject is shown.

In this manner, even in a case where the generation apparatus 1 is configured to start emitting radiation from the second frame or a case where the timing at which the generation apparatus 1 emits radiation is erroneously shifted for some reason, it is possible to avoid erroneously selecting a frame in which the subject is not shown.

In a case where the set irradiation frame rate is the first irradiation frame rate, since the subject is shown in all frames, steps S2 to S4 in the dynamic image editing process may be skipped (only the storage of frames may be performed).

The dynamic image editing process may be performed after all frames have been acquired from the imaging apparatus 2. In this case, since it is necessary to store a plurality of frames in advance before the start of this process, step S1 in the dynamic image editing process is unnecessary.

The display controller 31 has a function of displaying the edited dynamic image on the display 34.

The display controller 31 may display the edited dynamic image while performing the dynamic image editing process (or as a step in the dynamic image editing process), or after the repetition of the process ends.

As described above, frames in which the subject is not shown are already thinned out from the edited dynamic image. Accordingly, the dynamic image displayed on the display 34 shows the subject captured at the set irradiation frame rate.

[Flow of Imaging]

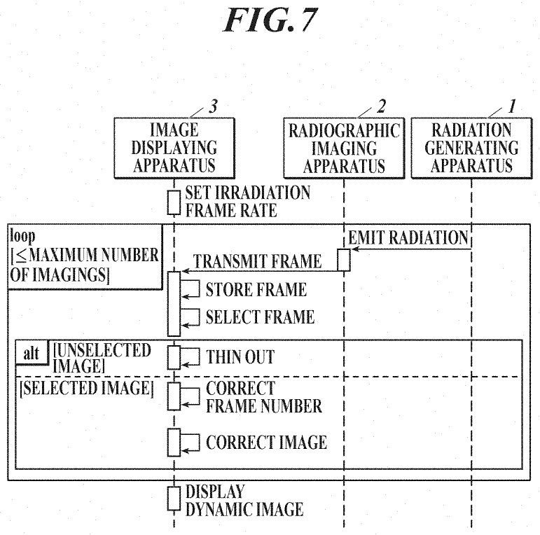

Next, the flow of imaging in the case of capturing a dynamic image at the second irradiation frame rate by using the system 100 will be described. FIG. 7 is a sequence diagram illustrating the operation of the system 100.

First, preparation for imaging is performed. Specifically, the radiographer configures the settings for dynamic imaging in the generation apparatus 1 and the imaging apparatus 2, and further sets the irradiation frame rate to the second irradiation frame rate (N/M fps) in the generation apparatus 1.

The radiographer places a subject between the generation apparatus 1 and the imaging apparatus 2.

After the completion of preparation for imaging, when the radiographer operates the irradiation switch 12, the generation apparatus 1 repeatedly applies a radiation pulse to the subject and the imaging apparatus 2 behind the subject every M/N seconds.

On the other hand, the imaging apparatus 2 repeatedly generate a frame every M/N seconds. As a result, a dynamic image in which the subject is shown every M frames ((M−1) frames in which the subject is not shown are interposed between frames in which the subject is shown).

The imaging apparatus 2 transmits the generated frames to the image displaying apparatus 3.

The image displaying apparatus 3 performs the dynamic image editing process described above each time any one of a plurality of transmitted frames is acquired. That is, the frame is stored, and it is determined whether or not the frame is to be used for display.

Then, if it is determined that the frame is not to be used for the display, the image displaying apparatus 3 thins out the frame.

On the other hand, if it is determined that the frame is to be used for the display, the image displaying apparatus 3 corrects the frame number, and performs image correction as necessary.

Then, the edited dynamic image, which is thus generated by the image displaying apparatus 3 repeating the dynamic image editing process, is displayed on the display 34.

Then, the radiographer checks the displayed dynamic image, and the imaging ends in a case where he/she determines that there is no problem.

In the system 100 according to the present embodiment configured as described above, the image displaying apparatus 3 thins out frames in which the subject is not shown and which are generated by the generation apparatus 1 that applies a radiation pulse at the second irradiation frame rate, so that it is possible to display an edited dynamic image composed of only the frames in which the subject is shown. In the case of capturing a dynamic image composed of a series of a plurality of frames, even if the imaging apparatus 2 supports only imaging at the predetermined first irradiation frame rate, it is possible to capture a dynamic image at different irradiation frame rates.

### Second Embodiment

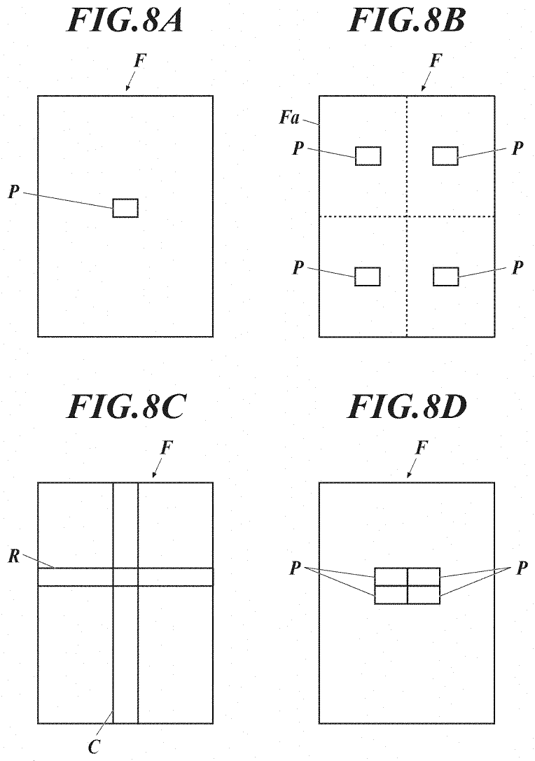

Next, a second embodiment of the invention will be described, with reference to FIG. 8A to FIG. 8D and the like. The same components as those in the first embodiment are denoted by the same reference numerals, and the description thereof will be omitted.

A radiographic imaging system (hereinafter, referred to as a system 100A) according to the present embodiment is different from that of the first embodiment in the method of selecting frames to be used for display from a plurality of stored frames.

Therefore, a dynamic image editing process performed by an image displaying apparatus 3A (a program stored in a display storage 33A) is different from that performed by the image displaying apparatus 3 of the first embodiment.

Specifically, in step S4 of the dynamic image editing process in the first embodiment, determination as to whether or not to use a frame for display is made based on the accessory information attached to the dynamic image. However, in step S4A of the dynamic image editing process of the present embodiment, the determination as to whether or not to use a frame for display is made based on the pixel value of a predetermined pixel in the frame of the dynamic image.

Specifically, it is determined that each frame is to be used for display if the pixel value of a predetermined region of the frame is equal to or greater than a predetermined value, and it is determined that each frame is not to be used for display if the pixel value of the predetermined region of the frame is less than the predetermined value.

For example, As a pixel P from which the pixel value is extracted for determination, a single pixel may be selected from the central portion of the frame F as illustrated in FIG. 8A, or a single pixel may be selected from each of a plurality of regions Fa of the frame F (for example, four regions of the upper right, upper left, lower right, and lower left of the frame F) as illustrated in FIG. 8B.

Alternatively, a plurality of pixels P forming a single row R or column C of the frame F may be selected as illustrated in FIG. 8C, or a plurality of pixels Pin a plurality of rows and columns may be selected as illustrated in FIG. 8D.

In the case of selecting a plurality of pixels P, it is preferable to use the average value or the median value of the pixel values of the pixels P for determination.

Instead of the pixel value, the determination may be made based on the data size of each frame. A frame in which the subject is not shown tends to have a smaller data size than a frame in which the subject is shown since the pixel values are almost uniform on the whole. Based on this, it can be determined that each frame is to be used for display if the data size is equal to or greater than a predetermined value, and it can be determined that each frame is not to be used for display if the data size is less than the predetermined value.

Since the image displaying apparatus 3 of the present embodiment does not require the irradiation frame rate to determine whether or not each frame is to be used for display, a function of setting the irradiation frame rate may be excluded.

In the case of selecting a frame based on the irradiation frame rate and the accessory information as in the system 100 of the first embodiment described above, if the timing at which the generation apparatus 1 emits radiation is erroneously shifted for some reason, there is a possibility that the image displaying apparatus 3 will select only the frame in which the subject is not shown. In contrast, since the system 100A according to the present embodiment determines whether or not each frame is to be used for display based on the magnitude of the pixel value, that is, whether or not the subject is reflected, it is possible to reliably avoid selecting a frame in which the subject is not shown.

Among the methods of capturing a dynamic image, there is a method of switching the irradiation frame rate in the middle of imaging (for example, the irradiation frame rate is set at the first irradiation frame rate at the start of imaging, changed to the second irradiation frame rate in the middle of the imaging, and then returned to the first irradiation frame rate again).

In the dynamic image obtained by such imaging, a frame in which the subject is reflected is not necessarily included every predetermined number of sheets (at equal intervals). Therefore, in the case of selecting a frame based on the irradiation frame rate and the accessory information as in the system 100 of the first embodiment, a part of the frame in which the subject is reflected cannot be selected. However, the system 100A according to the present embodiment determines whether or not to use each frame for display based on whether or not the subject is reflected. Therefore, even for the dynamic image in which a frame, in which the subject is reflected, is not included every predetermined number of sheets, it is possible to reliably select a frame in which the subject is reflected.

In the system 100A according to the present embodiment, the irradiation frame rate may be calculated and set based on the pixel values of a predetermined pixel in the frames.

In order to calculate the irradiation frame rate, there is a method of inversely determining the irradiation frame rate from the cycle at which a pixel value equal to or greater than a predetermined value is detected, for example.

In this case, the calculated irradiation frame rate may be output to other apparatuses through the communicator 32.

In this manner, for example, even if the system 100A is configured such that image displaying apparatus 3A do not transmit and receive signals or information to and from (do not cooperate with) the generation apparatus 1 or the imaging apparatus 2, it is possible to take measures, such as automatically linking the irradiation frame rate calculated by itself to the edited dynamic image (without manually inputting the irradiation frame rate) and outputting the irradiation frame rate to other systems (PACS and the like) or other apparatuses (analyzers or storage devices).

By imparting such an irradiation frame rate calculation function, the image displaying apparatus 3A can be configured to select first few frames based on pixel values while calculating the irradiation frame rate, and then to select the remaining frames based on the irradiation frame rate and the frame number as in the first embodiment.

In this manner, it is possible to simultaneously achieve the effect of quick display in the first embodiment and the effect of reliable selection of a frame in which the subject is shown in the second embodiment.

In the above description, an example using a semiconductor memory or a hard disk as a computer readable medium of a program according to the invention has been disclosed, but the invention is not limited to this example.

As for other computer readable media, it is possible to apply a non-volatile memory, such as a flash memory, and a portable recording medium, such as a CD-ROM.

As for a medium for providing the data of the program according to the invention through a communication line, a carrier wave is also applicable to the invention.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image displaying apparatus, comprising: a hardware processor that:
acquires a series of frames of a dynamic image from a radiographic imaging apparatus that generates the series of frames at a predetermined imaging frame rate based on received radiation;
stores the acquired series of frames in a storage;
selects frames to be used for display from the series of frames stored in the storage by picking up a frame from every predetermined number of frames; and
displays an edited dynamic image composed of the selected frames on a display.

2. The image displaying apparatus according to claim 1, wherein the hardware processor:
sets an irradiation frame rate of a radiation generating apparatus capable of generating radiation at predetermined irradiation frame rates; and
selects the frames to be used for display based on the set irradiation frame rate and accessory information attached to the dynamic image.

3. The image displaying apparatus according to claim 1, wherein the hardware processor selects the frames to be used for display based on a pixel value of a predetermined pixel in each of the series of frames.

4. The image displaying apparatus according to claim 2, wherein the hardware processor:
calculates and sets the irradiation frame rate based on a pixel value of a predetermined pixel in each of the series of frames; and
outputs the calculated irradiation frame rate to another apparatus.

5. A radiographic imaging system, comprising:
a radiographic imaging apparatus that generates a series of frames of a dynamic image at a predetermined imaging frame rate based on received radiation; and
the image displaying apparatus according to claim 1.

6. A non-transitory recording medium storing a computer-readable program causing a computer to:
acquire a series of frames of a dynamic image from a radiographic imaging apparatus that generates the series of frames at a predetermined imaging frame rate based on received radiation;
store the acquired series of frames in a storage;
select frames to be used for display from the series of frames stored in the storage by picking up a frame from every predetermined number of frames; and
display an edited dynamic image composed of the selected frames on a display.
